(19) United States
(12) Patent Application Publication
(10) Pub. No.: US 2026/0275030 A1
(43) Pub. Date: Sep. 17, 2026

(54) METHODS OF MAKING AND USING BIODEGRADABLE PLASTIC PRODUCTS AND PRODUCTS THEREOF

(71) Applicant: M-R Products, LLC., Copemish, MI (US)

(72) Inventors: Ryan Schultz, Copemish, MI (US); Dennis Stacey, Copemish, MI (US)

(21) Appl. No.: 19/464,164

(22) Filed: Jan. 29, 2026

Related U.S. Application Data
(60) Provisional application No. 63/752,268, filed on Jan. 31, 2025.

(51) Int. Cl. C08G 63/16; B33Y 80/00; C08G 63/08; C08J 3/24; C08J 3/28

(52) U.S. Cl. CPC C08G 63/16; C08G 63/08; C08J 3/24; C08J 3/28; B33Y 80/00; C08G 2230/00; C08J 2367/02; C08J 2367/04

(57) ABSTRACT

A biodegradable plastic chain is disclosed, comprising a polymer blend in which the major component is sourced from plant-derived monomers and/or polymers, including polylactic acid, polybutylene succinate, or polycaprolactone. The chain is formed into interlocking links and may include additives such as ultraviolet stabilizers, antioxidants, compatibilizers, plasticizers, and nucleating agents to enhance durability and environmental stability. The chain exhibits good mechanical strength and maintains structural integrity for several months under standard use conditions. It is designed for controlled biodegradation in industrial composting, soil burial, or marine environments, decomposing at least 30 percent within 180 days under industrial composting conditions. Methods of manufacturing and using the biodegradable chain are also disclosed.

### CROSS REFERENCE

The present application claims priority to U.S. Provisional Application No. 63/752,268, filed on Jan. 31, 2025, the contents of which are incorporated by reference in their entirety.

### TECHNICAL FIELD

This invention relates to industrial-grade plastic chains, specifically biodegradable plastic chains that decompose naturally under environmental conditions, reducing long-term plastic waste accumulation.

### BACKGROUND

Traditional chains are commonly made from either metal or plastic. Metal chains, while durable, have significant drawbacks, including susceptibility to rust and corrosion in outdoor environments and a long decomposition time when discarded. These factors contribute to material waste and environmental degradation over extended periods.

Plastic chains, on the other hand, are lightweight and resistant to corrosion but present significant environmental concerns. Conventional plastic materials can persist in the environment for centuries, breaking down into harmful microplastics that pollute ecosystems and pose risks to wildlife. Additionally, many existing biodegradable plastics lack the necessary mechanical properties to serve as a reliable substitute for traditional plastic or metal chains, exhibiting reduced tensile strength, UV resistance, and durability.

### SUMMARY

The present invention relates to a biodegradable plastic chain formed from a polymer blend in which the major component is sourced from plant-derived monomers and/or polymers, including polylactic acid, polybutylene succinate, or polycaprolactone. The polymer blend is processed into interlocking links that maintain structural integrity for several months under standard use conditions. The invention encompasses methods of manufacturing the biodegradable chain, which involve selecting the appropriate biodegradable polymer blend, forming it into a chain structure, and cooling or solidifying the structure to ensure long-term durability. The chain may be further enhanced with additives such as ultraviolet stabilizers, antioxidants, compatibilizers, plasticizers, and nucleating agents to improve environmental stability, mechanical strength, and resistance to degradation before disposal.

The invention further provides a method of using the biodegradable chain, including deploying it to support a mechanical load or connecting two or more structures. The chain is designed to maintain its mechanical properties over an extended period while undergoing controlled biodegradation in industrial composting, soil burial, or marine environments. It is engineered to degrade by at least 30 percent within 180 days under industrial composting conditions, ensuring a balance between functional durability and environmentally responsible disposal. The polymer matrix is formulated to resist premature degradation under high humidity conditions while enabling hydrolytic breakdown upon disposal. The biodegradable plastic chain serves as a viable alternative to conventional plastic chains, offering comparable mechanical properties while reducing long-term environmental impact.

### BRIEF DESCRIPTION OF THE DRAWINGS

The accompanying drawings are provided solely for illustrative and exemplary purposes and are not intended to limit the scope of the invention in any way. The invention is defined solely by the appended claims, which set forth the full scope of the invention. The drawings are merely illustrative examples to assist in understanding certain embodiments and implementations of the invention and should not be construed as limiting the invention to the specific structures or methods shown. Any variations or modifications within the scope of the claims are to be considered as part of the invention.

The FIGURE illustrates a chain length according to an aspect of the present invention.

### DETAILED DESCRIPTION

The present invention broadly relates to the development of biodegradable plastic products derived from plant biomass that has been processed into strong, durable polymeric materials. By leveraging advancements in polymer science, the invention transforms plant-based raw materials into high-performance biodegradable plastics that exhibit mechanical properties comparable to traditional petroleum-based polymers.

While the primary embodiment described herein focuses on biodegradable plastic chains, this technology extends to a variety of industrial and consumer applications. The same biodegradable polymers used to manufacture chains can be adapted to create structural components, such as load-bearing or high-strength plastic parts for temporary or permanent constructions. They can also be utilized in the production of ropes and cords, offering durable, biodegradable alternatives to synthetic polymer ropes commonly used in marine, agricultural, and industrial applications. Additionally, these materials can be employed in fencing and barriers, providing eco-friendly solutions for temporary crowd control, agricultural enclosures, and environmental protection zones.

The biodegradable polymers are further suitable for fasteners and connectors, including biodegradable nuts, bolts, and cable ties for industrial and household use. In packaging applications, they can be formed into strong and flexible wrapping films, crates, and containers that decompose safely over time, reducing plastic waste. Consumer goods such as reusable bags, utensils, furniture components, and gardening tools can also be manufactured using these materials, providing sustainable alternatives to conventional plastic products.

Moreover, these biodegradable materials have significant medical applications, including the production of biodegradable sutures, implants, and orthopedic supports that dissolve safely in the body over time. This broad range of applications highlights the versatility and potential of biodegradable polymer technology, offering sustainable solutions across multiple industries while reducing reliance on petroleum-based plastics.

By employing plant-derived biopolymers, this invention reduces dependence on fossil fuels, which are finite resources and contribute significantly to greenhouse gas emissions. Unlike petroleum-based plastics, biodegradable polymers derived from renewable plant biomass offer a sustainable alternative that helps mitigate long-term environmental pollution. These materials break down through natural biological processes, reducing the accumulation of plastic waste in landfills and oceans.

Moreover, the production of biodegradable plastics often involves lower carbon emissions and energy consumption compared to traditional plastic manufacturing. Since these materials are sourced from agricultural byproducts such as cornstarch, sugarcane, or cellulose, they promote a circular economy where waste materials are repurposed rather than discarded.

The broad scope of potential applications for biodegradable plastics highlights their versatility, making them an ideal solution for industries seeking to transition toward more sustainable manufacturing practices. Industries such as packaging, agriculture, construction, and consumer goods can benefit from integrating biodegradable materials into their product lines, reducing their environmental footprint while meeting increasing regulatory and consumer demands for eco-friendly alternatives. Additionally, biodegradable plastics can alleviate the growing concern over microplastic pollution, as they degrade into harmless natural compounds rather than persisting in the environment for centuries.

As innovation in biodegradable materials continues to advance, these plant-based polymers are expected to play a crucial role in reducing global plastic waste while maintaining the mechanical properties needed for a wide range of industrial and consumer applications.

### Harvesting and Processing Plant-Based Polymeric Materials

The process of producing plant-based biodegradable polymer materials begins with the selection and cultivation of renewable feedstocks, including starch-rich crops such as corn, sugarcane, cassava, and wheat, as well as lignocellulosic biomass from agricultural residues, forestry byproducts, and dedicated energy crops. These plant-based raw materials serve as the primary sources of fermentable sugars and other precursor chemicals necessary for monomer production. The specific feedstock used can influence the composition and quality of the resulting polymer, as different plant species contain varying concentrations of carbohydrates, lipids, and secondary metabolites that impact both yield and efficiency.

For polylactic acid (“PLA”), the primary raw material is typically corn starch or sugarcane-derived sucrose. These crops undergo enzymatic hydrolysis or acid hydrolysis to break down complex carbohydrates into simple sugars, primarily glucose. The extracted glucose is then fermented by lactic acid bacteria, such as Lactobacillus, under controlled conditions to produce lactic acid, a monomer unit. This fermentation process can introduce minor impurities, including unconverted sugars, organic acids, and residual microbial biomass, which must be removed through purification steps such as filtration, ion exchange, and distillation. The purified lactic acid is then subjected to ring-opening polymerization, often using catalysts such as tin(II) octanoate, to produce high-molecular-weight PLA. The polymerization process can introduce additional impurities such as residual catalysts, unreacted monomers, and oligomers, which may need further purification.

Polybutylene succinate (“PBS”) is derived from succinic acid and 1,4-butanediol, both of which are monomer units that can be produced from biomass. Succinic acid is traditionally obtained from petroleum-based sources, but biobased production methods employ microbial fermentation using bacteria such as Actinobacillus succinogenes or Escherichia coli engineered to convert glucose or glycerol into succinic acid. The fermentation process may yield byproducts such as acetic acid, formic acid, and fumaric acid, which require separation via crystallization or solvent extraction. The purified succinic acid is then reacted with 1,4-butanediol-often produced through hydrogenation of succinic acid or derived from biobased sources such as sugarcane or lignocellulosic biomass-under polycondensation conditions to form PBS. During polymerization, potential impurities include residual catalyst residues, oligomers, and unreacted monomers, which must be minimized to maintain polymer quality.

Polycaprolactone (“PCL”) is synthesized through the ring-opening polymerization of F-caprolactone or epsilon-caproctone, its monomer unit, which can be derived from petrochemical sources or synthesized via biobased methods using renewable precursors such as lignocellulose-derived furfural. In biobased production, F-caprolactone can be obtained through microbial conversion of fatty acids derived from plant oils such as palm oil, soybean oil, or castor oil. Enzymatic oxidation or selective chemical oxidation of these fatty acids can yield hydroxycarboxylic intermediates, which are then converted to F-caprolactone through lactonization reactions. Impurities in this process may include residual organic acids, aldehydes, and metal catalysts from oxidation reactions, which are typically removed through distillation and solvent extraction. The polymerization of F-caprolactone, commonly catalyzed by tin(II) octanoate or aluminum alkoxides, results in PCL with tunable molecular weight and biodegradability.

Modified polyolefins, though not inherently biodegradable, can be engineered with functional groups to enhance environmental degradation. Bio-based polyolefins, such as polyethylene derived from sugarcane ethanol, provide a renewable alternative to fossil-fuel-based plastics but require chemical modifications, such as the incorporation of pro-oxidant additives or blending with biodegradable polyesters, to improve their breakdown properties. In some cases, polyhydroxyalkanoates (PHA), which are fully biodegradable polyesters synthesized directly by bacteria from sugar or lipid feedstocks, are incorporated to enhance biodegradability. PHA production involves bacterial fermentation, followed by solvent extraction and precipitation to isolate the polymer, with common impurities including cell debris, residual solvents, and unreacted precursors.

Throughout these processes, various physical and chemical separation techniques, including filtration, centrifugation, crystallization, distillation, and solvent extraction, are employed to purify the monomers and polymers. The removal of residual catalysts, unreacted monomers, and byproducts is critical to achieving consistent material properties and ensuring the final polymer meets industrial and environmental standards. The choice of feedstock, microbial strains, catalysts, and purification techniques ultimately determines the efficiency, sustainability, and biodegradability of the resulting polymeric materials.

### Material Composition

The biodegradable plastic chain and other products are made from one or more biodegradable polymers derived from plant-based alternatives to traditional petroleum-based plastics. The polymerization process incorporates biobased feedstocks such as PLA, PBS, PCL, modified polyolefins, and/or starch-based blends. PLA can be derived from renewable resources like corn starch or sugarcane, providing high tensile strength along with biodegradability under industrial composting conditions. PBS, synthesized from succinic acid and 1,4-butanediol, offers enhanced flexibility and thermal stability while maintaining biodegradability under composting and soil burial conditions. PCL, formed through ring-opening polymerization of ε-caprolactone, provides excellent elongation properties and hydrolytic degradation, making it particularly useful in environments with high moisture exposure.

Modified polyolefins may be engineered to retain durability and mechanical properties similar to traditional petroleum-based polymers while offering enhanced environmental breakdown capabilities. Starch-based blends may further enhance biodegradability in soil and marine environments. Additional additives may be incorporated to improve UV resistance, thermal stability, and mechanical performance, ensuring that the biodegradable plastic chain meets the mechanical and environmental requirements of industrial and consumer applications.

As one of ordinary skill in the art would appreciate, these materials may be blended to control physical properties. In this event, compatibilizers may be necessary. Compatibilizers, such as surfactants, block copolymers, or grafted functionalized polymers, help improve interfacial adhesion and miscibility of otherwise incompatible polymer phases. Without a compatibilizer, immiscible polymer blends may suffer from phase separation, leading to compromised mechanical properties. The use of compatibilizers enhances the uniformity of the polymer mixture, improving tensile strength, impact resistance, and elongation properties.

Additionally, certain polymers within the blend may be crosslinked to improve structural integrity and stability. Crosslinking can occur through chemical means, such as peroxide or silane-induced reactions, or through radiation techniques like electron beam or ultraviolet exposure. In some cases, in situ crosslinking may be employed, where a polymer crosslinks to itself during processing, enhancing mechanical durability and resistance to environmental degradation. This approach locks the polymer molecules together, creating a more robust and durable material that still retains the benefits of biodegradability.

As used herein, “biodegradable” refers to the ability of a material to undergo breakdown by the action of microorganisms, moisture, and oxygen into environmentally benign byproducts, such as carbon dioxide, water, and biomass. Unless otherwise specified, biodegradability is determined under industrial composting conditions comprising a temperature of at least 10° C., a moisture content of 40-60% by weight in the composting medium, an oxygen concentration in the gaseous phase of the composting medium of 12-15% by volume, and a carbon-to-nitrogen ratio of 25:1 to 30:1. Under these conditions, the polymer matrix is expected to degrade by at least 30 percent by mass within 180 days, as measured by standardized composting tests such as ASTM D5338 or ISO 14855. Alternative biodegradability testing environments may include soil burial, marine water, or anaerobic digestion, where degradation rates and mechanisms may vary based on microbial activity, temperature, and moisture availability.

By optimizing compatibilizers and crosslinking techniques, the resulting biodegradable plastic chain can achieve enhanced performance characteristics, allowing it to serve as a viable alternative to conventional plastic and metal chains in industrial applications. These modifications ensure that the material maintains its desired properties over its useful lifespan while breaking down in environmentally friendly ways upon disposal.

### Physical Properties

The physical properties of biodegradable polymers, such as tensile strength, elongation at break, modulus, melting point, glass transition temperature, and biodegradability, are largely dictated by the polymer's chain length and composition. Small amounts of additives introduced during polymerization can be used to control chain length, thereby influencing material performance.

Tensile strength and modulus are primarily controlled by molecular weight and crystallinity. Longer polymer chains and increased crystallinity result in stronger, stiffer materials, whereas shorter chains and lower crystallinity provide greater flexibility. Chain extenders and branching agents can be added to modify polymer architecture and enhance tensile strength. For example, adding a chain transfer agent (“CTA”) can shorten polymers because it starts new polymer chains, making propagation less likely and termination more likely. Therefore, the kinetics will favor shorter polymer chains. CTAs therefore play a crucial role in controlling molecular weight and polymer architecture during polymerization.

For polyolefins, common CTAs include hydrogen gas, which is widely used in Ziegler-Natta and metallocene catalysis to regulate polymer chain length. Aluminum alkyls, such as triethylaluminum, and organozinc compounds like diethylzinc are also employed, particularly in coordination polymerization. Other effective CTAs include organotin compounds (e.g., tributyltin hydride), alkyl halides (e.g., ethyl bromide, n-butyl chloride), and boranes (e.g., triethylborane, BEt₃), which are more commonly used in radical polymerization systems. Certain alkanes (e.g., isobutane, hexane, octane) and cycloalkanes (e.g., cyclohexane) can also function as CTAs in gas-phase or slurry-phase polymerizations, while silanes (e.g., triethylsilane) provide additional control in radical-mediated systems.

For PLA synthesis, particularly via ring-opening polymerization, common CTAs include alcohols (e.g., ethanol, butanol, benzyl alcohol), water, and carboxylic acids (e.g., lauric acid, benzoic acid), which help regulate molecular weight. Polyols, such as glycerol and pentaerythritol, are used to introduce branching, while amines (e.g., ethylenediamine, hexamethylenediamine) and sulfur-containing compounds (e.g., thiols, dodecanethiol, mercaptoethanol) serve as effective chain terminators. Other important CTAs include phosphines (e.g., triphenylphosphine), metal alkoxides (e.g., tin(II) ethoxide, aluminum isopropoxide), and silanols (e.g., trimethylsilanol). Additionally, diols such as ethylene glycol and 1,4-butanediol are frequently used to tailor degradation properties and copolymer structures.

For PCL, which is synthesized via ring-opening polymerization of ε-caprolactone, common chain transfer agents include alcohols such as methanol, ethanol, and benzyl alcohol, which help regulate polymer chain length by terminating growing chains. Carboxylic acids, including acetic acid and lauric acid, can also serve as effective chain transfer agents, controlling molecular weight and influencing degradation properties. Thiols such as mercaptoethanol and dodecanethiol are frequently used in polycaprolactone polymerization to modify end-group functionality and enhance hydrolytic degradation rates. Organometallic compounds, including tin(II) octanoate and aluminum isopropoxide, may also influence polymerization kinetics, acting as both catalysts and chain transfer agents to tailor molecular weight distributions. The selection of chain transfer agents for polycaprolactone allows for precise control over mechanical and biodegradation properties, making it adaptable for applications requiring tunable flexibility and controlled environmental breakdown.

For polybutylene succinate, which is synthesized via polycondensation of succinic acid and 1,4-butanediol, common chain transfer agents include monofunctional alcohols such as methanol, ethanol, and benzyl alcohol, which terminate polymer chains and regulate molecular weight distribution. Carboxylic acids, including acetic acid and lauric acid, can also serve as effective chain transfer agents, influencing polymer crystallinity and biodegradation rate. Thiols such as dodecanethiol and mercaptoethanol may be used to introduce controlled end-group functionality, enhancing hydrolytic degradation while modifying mechanical properties. Metal alkoxides, including aluminum isopropoxide and tin(II) ethoxide, can act as both catalysts and chain transfer agents, enabling fine-tuned polymer architecture. The selection of chain transfer agents for polybutylene succinate is critical for optimizing its balance of tensile strength, flexibility, and biodegradability, making it suitable for applications requiring controlled mechanical performance and environmental breakdown.

In radical polymerization, azobisisobutyronitrile is a widely used initiator that can also function as a chain transfer agent by fragmenting into radical species that terminate or transfer chains. While AIBN is more commonly known for its initiation role, its presence in polymerization systems can influence molecular weight distribution by participating in secondary chain transfer reactions.

Branching agents are essential for modifying polymer architecture, improving melt strength, and enhancing mechanical properties in polyolefins and PLA. Unlike chain transfer agents, branching agents allow the polymerchain to split to create a branched chain instead of a linear change. This fundamental chain in the polymer architecture may have large influence over physical properties as discussed herein.

For polyolefins, branching can be introduced via several types of agents. α-Olefins, such as 1-butene, 1-hexene, and 1-octene, are commonly used in polyethylene and polypropylene polymerization to create short-chain branches that improve flexibility and toughness. Multifunctional vinyl or dienes, such as 1,7-octadiene, 1,9-decadiene, and norbornadiene, are used to introduce long-chain branching, particularly in metallocene-catalyzed polymerizations. Silane crosslinking agents, such as vinyltrimethoxysilane, enable the formation of crosslinked polyolefins via moisture curing. Polyfunctional acrylates, including trimethylolpropane triacrylate and pentaerythritol triacrylate, are used in radical polymerization to create highly branched or crosslinked structures. Additionally, peroxide-induced branching, using compounds like dicumyl peroxide, is common in high-melt-strength polypropylene production.

For PLA, branching is often introduced to improve melt strength, processability, and thermal stability, which are otherwise limited by its linear structure. Polyfunctional alcohols, such as glycerol, pentaerythritol, and trimethylolpropane, are frequently used as branching agents in ring-opening polymerization of lactide, allowing for controlled hyperbranching. Multifunctional carboxylic acids, including citric acid and trimesic acid, can also be incorporated to introduce branching. Epoxide-functionalized branching agents, such as Joncryl reactive chain extenders, react with the hydroxyl and carboxyl groups in PLA, promoting branching and molecular weight enhancement. Peroxides, including benzoyl peroxide and DCP, can be used in reactive extrusion to create controlled branching via radical mechanisms. Isocyanates, such as hexamethylene diisocyanate, react with hydroxyl groups to introduce branching while also acting as a chain extender. In some cases, silane coupling agents, such as γ-glycidoxypropyltrimethoxysilane, can be employed to promote branching and crosslinking.

For PBS, branching is often introduced to enhance melt strength, impact resistance, and thermal stability while maintaining biodegradability. Polyfunctional alcohols, such as glycerol, pentaerythritol, and trimethylolpropane, are commonly used as branching agents during polycondensation, introducing controlled branching without significantly compromising mechanical integrity. Multifunctional carboxylic acids, including citric acid and pyromellitic acid, can also be incorporated to create a more crosslinked polymer network, improving structural rigidity. Epoxide-functionalized branching agents, such as glycidyl methacrylate and diepoxide compounds, react with carboxyl and hydroxyl groups in polybutylene succinate, promoting branching while increasing molecular weight. Peroxides, such as dicumyl peroxide and benzoyl peroxide, can be utilized in reactive extrusion to induce controlled branching via free radical mechanisms. In some cases, silane-based branching agents, such as vinyltrimethoxysilane, can be employed to introduce reactive sites that enable post-processing crosslinking, further improving environmental resistance and durability.

For PCL, branching is often used to improve viscosity, melt strength, and mechanical performance while ensuring that the material retains its biodegradability and flexibility. Polyfunctional alcohols, such as glycerol, sorbitol, and pentaerythritol, can be added during ring-opening polymerization of F-caprolactone to introduce controlled branching, enhancing both processability and elasticity. Multifunctional carboxylic acids, including citric acid and trimesic acid, promote branching while modulating hydrolytic degradation rates. Epoxide-based branching agents, such as diepoxide compounds and glycidyl esters, react with hydroxyl end groups in polycaprolactone to extend chain length and increase molecular weight. Radical initiators, including peroxides like dicumyl peroxide and tert-butyl peroxybenzoate, enable branching through free radical grafting reactions, improving melt stability in processing. In certain cases, silane-based agents, such as γ-glycidoxypropyltrimethoxysilane, facilitate reactive branching and potential crosslinking, enhancing polycaprolactone's resistance to premature degradation while maintaining controlled environmental breakdown.

Each of polyolefins, PLA, PCL, and PBS rely on branching agents to enhance rheological properties, melt strength, and end-use performance, with the specific choice of branching agent depending on the polymerization method and desired material properties.

Elongation at break is influenced by polymer flexibility and intermolecular interactions. Plasticizers such as citrate esters or polyethylene glycols may be added to increase elongation by reducing intermolecular forces and increasing free volume within the polymer matrix. Plasticizers are essential additives used to enhance the flexibility, processability, and durability of polymers. Among the most traditional plasticizers are phthalates, including di(2-ethylhexyl) phthalate, dioctyl phthalate, diisononyl phthalate, diisodecyl phthalate, butyl benzyl phthalate, diethyl phthalate, dimethyl phthalate, and di-n-octyl phthalate. While widely used, regulatory concerns over their potential health effects have led to increased demand for alternatives. Non-phthalate plasticizers include di(2-ethylhexyl) terephthalate, diisononyl cyclohexane-1,2-dicarboxylate, acetyl tributyl citrate, triacetin, polyadipates such as di(2-ethylhexyl) adipate, epoxidized soybean oil, glycerol esters like glycerol monostearate, polymeric plasticizers such as polyester adipates, phosphate esters including triethyl phosphate and triphenyl phosphate, as well as sulfonamides like N-ethyl toluenesulfonamide and N-butyl benzene sulfonamide.

Bio-based and renewable plasticizers include epoxidized linseed oil, castor oil derivatives such as acetylated castor oil, cardanol-based plasticizers derived from cashew nut shell liquid, succinates like diethyl succinate, itaconates such as methyl itaconate, sebacates like dibutyl sebacate, citrate-based plasticizers including tributyl citrate, fumarates such as diethyl fumarate, and isosorbide esters. For high-performance applications requiring flame retardancy, chlorinated and halogenated plasticizers are often employed. These include chlorinated paraffins, chlorinated polyethylene, and brominated phthalates, which improve fire resistance and thermal stability in demanding environments. The choice of plasticizer depends on factors such as compatibility with the polymer matrix, regulatory compliance, processing requirements, and end-use performance criteria.

Melting point and glass transition temperature are controlled by monomer selection and polymer chain architecture. The incorporation of copolymers such as polycaprolactone can lower melting points and enhance processability while maintaining biodegradability. Conversely, increasing chain regularity and crystallinity can raise the melting point and enhance high-temperature performance.

Herein, biodegradability rate is measured in weight percent of the material that biodegrades per unit time in composting conditions. By composting conditions, this disclosure anticipates mixing the chain with organic matter in a controlled aerobic environment maintained at a temperature of approximately 58±2° C., with a relative humidity of at least 50%, and regular agitation to promote microbial activity and oxygenation. The composting matrix may consist of a blend of green waste (e.g., grass clippings, food scraps) and brown waste (e.g., sawdust, cardboard, dried leaves), and may have a carbon-to-nitrogen (C:N) ratio between 25:1 and 40:1. Under these conditions, biodegradation rate is quantified by measuring the loss in dry mass of the chain material or the evolved carbon dioxide relative to the original mass over a fixed interval (e.g., 45, 90, or 180 days). According to one aspect of the invention, the biodegradability rate may be 5 percent within 60 days, 10 percent within 60 days, 15 percent within 60 days or, more preferably, 20 percent within 60 days. When measured at 180 days, the biodegradability rate may be 30 percent within 180 days, 40 percent within 180 days, or 50 percent within 180 days.

Copolymers are widely used to modify the thermal properties of polyolefins and polylactic acid, particularly to control glass transition temperature and melting point. In polyolefins, ethylene-based copolymers such as ethylene-vinyl acetate, ethylene-methyl acrylate, ethylene-ethyl acrylate, and ethylene-butyl acrylate lower crystallinity and reduce the melting point, improving flexibility. Additionally, ethylene-propylene copolymers, including ethylene-propylene rubber and ethylene-propylene-diene monomer rubber, enhance impact resistance and reduce brittleness at low temperatures. Polyolefins can also be blended with styrenic block copolymers such as styrene-butadiene-styrene and styrene-ethylene-butylene-styrene, which provide enhanced elasticity and lower glass transition temperature. Other copolymers, including polybutene-1, propylene-ethylene copolymers, and polyethylene-co-maleic anhydride, allow for fine-tuning of thermal and mechanical properties.

For polylactic acid, copolymers such as polycaprolactone, polybutylene adipate-co-terephthalate, and polybutylene succinate are commonly used to reduce glass transition temperature and improve flexibility. The incorporation of polyhydroxyalkanoates, particularly polyhydroxybutyrate, helps lower the melting point while maintaining biodegradability. Random copolymers of lactic acid and glycolic acid, as seen in poly(lactic-co-glycolic acid), allow for precise control of thermal properties by adjusting monomer ratios. Additionally, polyethylene glycol and its copolymers with polylactic acid effectively reduce brittleness and enhance melt processability. Other common modifications include blends with polytrimethylene carbonate, which improves toughness, and copolymers with acrylic or methacrylic monomers, which alter thermal transitions for specific applications. The selection of copolymers depends on the desired balance between thermal performance, mechanical properties, and processing behavior.

Biodegradability is a critical physical property that can be modulated by controlling polymer backbone chemistry and the presence of hydrolyzable linkages. Enzymatically degradable copolymers such as polybutylene succinate can be blended with polylactic acid to adjust degradation rates. Additionally, the inclusion of hydrolytic catalysts or pro-oxidant additives can accelerate biodegradation under specific environmental conditions. Hydrolysis-sensitive copolymers, including polycaprolactone, polybutylene adipate-co-terephthalate, and polytrimethylene carbonate, introduce ester linkages that break down in the presence of water, making them useful for fine-tuning the degradation rate of polylactic acid. Hydrophilic polymers such as polyethylene glycol can increase water uptake and facilitate hydrolytic breakdown, whereas copolymerization with hydrophobic units like polyhydroxybutyrate can slow degradation in humid environments.

For oxidation-based degradation, metal-based pro-oxidant additives, including transition metal salts of cobalt, manganese, and iron, catalyze the breakdown of polyolefin chains by promoting oxidative cleavage when exposed to heat and ultraviolet light. These compounds generate free radicals that accelerate the fragmentation of polymer backbones, making them more susceptible to microbial attack. Peroxide initiators and unsaturated co-monomers, such as maleic anhydride-modified polyolefins, can further enhance oxidative degradation by introducing reactive sites along the polymer chain. The inclusion of ketone or ether functionalities in polyolefins also increases sensitivity to oxidative breakdown, allowing for greater environmental responsiveness.

Enzymatic degradation can be facilitated by incorporating natural polymers such as starch, cellulose, or chitosan, which provide microbial attachment points and enhance overall compostability. Blending polylactic acid or polyolefins with proteins such as casein or gelatin introduces additional biodegradable segments that increase microbial degradation rates. The use of aliphatic-aromatic copolyesters, such as those derived from terephthalic acid and adipic acid, can provide a controlled balance between stability and biodegradability, ensuring mechanical integrity during use while breaking down under composting or marine environments.

Water-sensitive and photodegradable linkages can also be introduced through copolymerization with anhydrides, amides, or urethanes, which hydrolyze or degrade under ultraviolet exposure. Polyvinyl alcohol-based copolymers dissolve in aqueous environments, making them particularly useful for controlled biodegradation applications. The selection of degradation-modifying additives or copolymers depends on the targeted end-use conditions, whether it be industrial composting, marine environments, or controlled degradation in soil. By carefully designing polymer formulations, manufacturers can tailor both the rate and mechanism of polymer breakdown to meet sustainability goals while maintaining performance requirements.

Additives play a crucial role in optimizing these physical properties. Crosslinking agents such as peroxides or silanes can be used to chemically bind polymer chains together, enhancing mechanical strength and thermal stability. Compatibilizers, including block copolymers and grafted polyolefins, improve interfacial adhesion in polymer blends, ensuring uniform material performance. Some additives, such as plasticizers and impact modifiers, are not chemically bound to the polymer chain but exist within the bulk composition, affecting the material's flexibility and toughness.

Nucleating agents are widely used to influence crystallization behavior, reducing cycle times during processing and improving optical clarity, thermal resistance, and mechanical properties. Common nucleating agents for polyolefins include sorbitol derivatives, benzoates, and phosphate esters, which promote uniform spherulite formation and enhance stiffness without compromising impact resistance. In polylactic acid, talc, calcium carbonate, and carbon nanotubes serve as effective nucleating agents, accelerating crystallization and improving heat deflection temperature, which is critical for applications requiring high thermal stability.

Antioxidants are another essential class of additives that protect polymers from oxidative degradation during processing and long-term use. These include hindered phenols, which act as primary antioxidants by scavenging free radicals, and phosphites or thioethers, which function as secondary antioxidants to decompose peroxides and prevent chain scission. In polyolefins, antioxidants such as tetrakis[methylene(3,5-di-tert-butyl-4-hydroxyhydrocinnamate)]methane improve resistance to thermal degradation, while in polylactic acid, ascorbic acid derivatives and tocopherols help maintain polymer integrity during high-temperature processing.

Ultraviolet stabilizers are essential for protecting polymers from photodegradation, which can lead to discoloration, brittleness, and loss of mechanical properties. Hindered amine light stabilizers, commonly used in polyolefins, function by scavenging free radicals generated from ultraviolet exposure, extending the material's lifespan in outdoor applications. In polylactic acid, benzophenone and benzotriazole derivatives absorb ultraviolet radiation and dissipate it as heat, minimizing polymer degradation under prolonged sun exposure.

Processing aids and lubricants help improve melt flow, reduce die buildup, and prevent sticking during extrusion or molding. In polyolefins, fluoropolymer-based processing aids reduce melt fracture and enhance surface finish, while metal stearates such as calcium stearate and zinc stearate act as internal lubricants, minimizing friction between polymer chains and improving processability. In polylactic acid, lactic acid oligomers and erucamide derivatives are often used to reduce melt viscosity and facilitate extrusion without compromising material properties.

Antimicrobial agents are increasingly incorporated into polymers for applications in medical, packaging, and consumer goods. In polyolefins, silver-based compounds, zinc oxide, and quaternary ammonium salts prevent bacterial growth and extend product lifespan. In polylactic acid, natural antimicrobial agents such as chitosan, cinnamaldehyde, and essential oil extracts provide biocidal effects while maintaining biodegradability.

Electrical and thermal conductivity modifiers enable specialized applications in electronic and heat-dissipating components. Conductive carbon black, graphene, and carbon nanotubes are added to polyolefins to enhance electrical conductivity and electromagnetic shielding properties. In polylactic acid, silver nanowires and boron nitride improve thermal conductivity, allowing for use in heat management applications while maintaining environmental sustainability.

By selecting the appropriate combination of additives, manufacturers can precisely tailor the performance of polyolefins and polylactic acid, optimizing their usability in diverse applications ranging from packaging and automotive components to medical devices and consumer electronics.

Balancing physical properties is essential to achieving the desired material performance. For example, increasing tensile strength often reduces elongation at break, and enhancing biodegradability can compromise long-term mechanical integrity. By carefully selecting monomers, polymer architecture, and additives, these conflicting properties can be optimized to meet the specific performance demands of biodegradable plastic chains.

### Biodegradable Chains, in General

The biodegradable plastic chain disclosed herein is constructed from a polymeric composition formulated to balance mechanical durability, environmental stability, and controlled biodegradation. The chain comprises interconnected links molded from a biodegradable polymer matrix, which may include polylactic acid, polybutylene succinate, polycaprolactone, or polyhydroxyalkanoates, either individually or in combination. The polymer blend may be tailored to achieve optimal tensile strength, impact resistance, and resistance to environmental degradation while maintaining the required load-bearing characteristics for industrial and commercial applications.

The chain exhibits a high degree of structural integrity, with individual links designed to distribute mechanical stress efficiently across their geometry. The polymer formulation may be reinforced with nucleating agents to promote controlled crystallization, enhancing rigidity and thermal stability. The material composition may be optimized to resist premature breakage under tensile loads, as demonstrated in load-bearing tests where the chain maintained structural integrity under sustained forces up to 25 pounds before significant elongation or link failure occurred.

In addition to mechanical strength, the biodegradable plastic chain may incorporate additives to improve ultraviolet resistance, heat aging stability, and oxidative degradation properties. The polymer matrix may be compounded with ultraviolet absorbers and hindered amine light stabilizers to prevent photodegradation in outdoor environments. This may ensure that the chain retains its mechanical properties and visual integrity when exposed to prolonged sunlight, as evidenced by UV resistance testing where no significant degradation was observed after 96 hours of ultraviolet exposure.

The thermal stability of the chain may be reinforced through the inclusion of antioxidants and heat stabilizers, which may prevent oxidative breakdown at elevated temperatures. Heat aging tests confirmed that the chain composition remained structurally stable after prolonged exposure to 55 degrees Celsius, with no significant loss in mechanical strength or deformation. The biodegradable composition may also integrate hydrolytically degradable linkages, allowing for controlled degradation in the presence of moisture. This controlled breakdown mechanism may ensure that the chain remains functional throughout its intended service life while enabling environmentally responsible disposal through composting or natural degradation in soil or marine environments.

The disclosed chain may maintain a balance between flexibility and stiffness, providing sufficient elasticity to absorb impact forces while preventing excessive elongation under sustained load. The results from load-bearing and tensile testing demonstrate a predictable deformation profile, with extension at maximum load values averaging 0.53 inches before failure. The chain may exhibit controlled creep behavior, ensuring long-term dimensional stability even under cyclic loading conditions.

The innovative combination of biodegradable polymer chemistry, mechanical reinforcement, and environmental stabilization additives may result in a chain structure that meets industrial durability requirements while offering a sustainable alternative to conventional plastic chains. The disclosed invention may provide a functional and environmentally responsible solution for applications where traditional plastic chains pose long-term waste management challenges.

Chain links made according to the present invention can be of any size or shape that functions as a chain length. Chain link shapes vary widely based on their intended function, structural integrity, and aesthetic appeal. Oval links are among the most common, providing a uniform and balanced shape for industrial and decorative applications. Round links distribute stress evenly, while twisted links enhance flexibility and visual appeal. Figure-eight links allow for increased articulation, and rectangular links offer a more elongated profile for specialized load-bearing needs. D-shaped links provide stability under tension with a flat side, whereas S-hook links enable quick attachment and detachment. Hexagonal links and triangular links introduce geometric strength, while flattened links improve surface contact.

Welded links ensure enhanced durability by fully closing the joint, while split links feature a small gap for temporary opening and closure. Knotted links mimic knotted rope patterns for decorative use, and double loop links add extra security with two interwoven loops. Interlocking links are specially shaped for a continuous connection, and barrel links introduce a cylindrical profile that allows for a rolling motion. Snake links create a tightly connected, flexible structure, while box links offer a dense, squared-off appearance for increased rigidity.

Mariner links include a reinforcing bar across the center for additional strength, and cable links follow a classic interlocking oval design similar to marine chains. Curb links feature a twisted shape that enables them to lay flat, while rope links are woven to resemble the texture of a rope. Ball-and-bar links alternate between spherical and elongated elements to create a structured pattern. More intricate designs, such as Byzantine links, incorporate interwoven elements for a decorative, complex look, while foxtail links use multiple interwoven links for a dense, flexible construction. Ladder links resemble a parallel rung structure, offering a distinct, sturdy profile. These various chain link designs cater to a wide range of industrial, commercial, and aesthetic applications, ensuring versatility in strength, flexibility, and appearance.

The shape of chain links plays a crucial role in determining the mechanical properties, load distribution, flexibility, and durability of a chain, ultimately influencing its functionality and performance in different applications. Link geometry affects tensile strength, as more rounded or oval links evenly distribute stress, reducing weak points that could lead to failure under load. In contrast, rectangular or D-shaped links introduce defined stress concentration areas, which can either enhance rigidity or create localized points of weakness, depending on the application.

Twisted and curb links are designed to lay flat, reducing unwanted rotation and tangling, which improves stability in load-bearing applications such as barrier chains or lifting mechanisms. Mariner links, with their reinforced center bar, enhance resistance to deformation under high loads, making them ideal for marine and heavy-duty industrial applications. Similarly, box links and foxtail links create dense, interwoven structures that increase overall chain stiffness and resistance to stretching, making them more durable under cyclic loading conditions.

For chains requiring high flexibility, such as decorative or wearable chains, snake links and rope links offer smooth movement with minimal friction between links, allowing for greater articulation. Ball-and-bar links and Byzantine links introduce structured articulation, controlling movement while maintaining a unique visual profile. In contrast, barrel links reduce friction by incorporating cylindrical elements that enable a rolling motion, minimizing wear over time.

Link shape also impacts fatigue resistance and longevity. Chains subjected to repeated stress cycles benefit from rounded and welded links, which prevent weak points from forming at connection points. In contrast, chains with sharp angles, such as hexagonal or ladder links, may experience higher stress concentrations at corners, leading to potential fatigue failure if not properly engineered.

Furthermore, split links and S-hook links prioritize functionality for quick assembly and disassembly, though they may sacrifice some strength compared to fully enclosed links. Interlocking and knotted links create additional friction between segments, increasing tensile strength but reducing overall flexibility.

By selecting the appropriate link shape, manufacturers can optimize the balance between strength, flexibility, and durability for specific applications, whether for heavy-duty load-bearing operations, flexible motion systems, or decorative and lightweight applications.

### Material Combinations and Alternate Chemistries

In addition to polylactic acid (“PLA”), polybutylene succinate (“PBS”), and polycaprolactone (“PCL”), the biodegradable polymer matrix of the present invention may further include alternative or supplemental biodegradable polymers, such as polyhydroxyalkanoates (“PHAs”), polybutylene adipate terephthalate (“PBAT”), or bio-based polyamides. These polymers offer complementary mechanical, thermal, and degradation characteristics that allow the material system to be tailored for specific applications.

PHAs are naturally occurring polyesters produced by microbial fermentation of renewable feedstocks, such as sugars or plant oils. Representative examples include polyhydroxybutyrate (“PHB”), polyhydroxyvalerate (“PHV”), and copolymers thereof. PHAs exhibit high biodegradability across a broad range of environmental conditions—including marine, soil, and anaerobic environments—and can be used to enhance environmental breakdown of the chain in non-composting scenarios. Additionally, PHA imparts increased stiffness and UV resistance, making it well-suited for outdoor applications.

PBAT, a petroleum-derived but biodegradable aromatic-aliphatic copolyester, may be blended with PLA or PBS to improve flexibility, toughness, and elongation at break. This is particularly advantageous in dynamic loading or high-strain applications where a more ductile polymer matrix is required. PBAT's degradation rate can also be tailored through blending, allowing it to serve as a modulator for hydrolysis-driven breakdown while maintaining compatibility with conventional composting processes.

Bio-based polyamides (e.g., PA11, PA410), derived from castor oil or other renewable sources, may be used to increase thermal stability, abrasion resistance, and fatigue endurance of the biodegradable chain. These polyamides provide enhanced strength-to-weight ratios and may be used in applications requiring heat exposure above 100° C. In some embodiments, partially degradable copolyamides or polyamide blends may be employed to extend functional life in harsh environments while ensuring eventual fragmentation and degradation.

The biodegradable plastic chain may also be fabricated using biocomposite formulations that incorporate natural fillers or reinforcements into the polymer matrix to enhance mechanical properties and environmental profile. Reinforcing agents may include lignocellulosic fibers such as hemp, flax, kenaf, jute, sisal, or bamboo; agricultural byproducts such as rice husk or wheat straw; or micro- and nano-cellulose structures derived from wood pulp or bacterial sources.

These fibers may be introduced into the biodegradable polymer blend at loading levels ranging from 5 to 40 percent by weight, depending on the target stiffness, density, and cost. For example, the incorporation of 20% kenaf fiber into a PLA/PBS blend has been shown to improve tensile modulus and dimensional stability under thermal stress. When properly surface-treated or compatibilized, these fibers may also improve interfacial adhesion within the matrix, yielding more uniform stress distribution and reduced crack propagation under cyclic loading.

In another embodiment, starch particulates or thermoplastic starch (“TPS”) may be used as a filler or co-continuous phase. Starch-based fillers accelerate biodegradation by providing microbial binding sites and enhancing water uptake into the polymer matrix. TPS may also serve as a low-cost, biodegradable bulking agent in applications where moderate mechanical strength is acceptable.

Microcrystalline cellulose (“MCC”), nanocellulose fibrils (“CNF”), or cellulose nanocrystals (“CNC”) may be added as high-performance reinforcement agents. These fillers impart high aspect ratio reinforcement, reduce thermal shrinkage, and improve nucleation during crystallization. Such enhancements may be beneficial in applications requiring dimensional precision, such as modular link systems, or where elevated load-bearing performance is critical.

In further embodiments, the biodegradable polymer matrix may be engineered to incorporate self-healing features or delayed degradation triggers, thereby extending functional lifespan or enabling controlled environmental breakdown after use. These formulations may include encapsulated hydrolytic agents, microbial substrates, or degradation accelerants that are released only under specified conditions such as elevated temperature, UV exposure, or physical damage.

One approach involves the use of microcapsules or nanocapsules embedded in the polymer that contain acidic or enzymatic degradation catalysts (e.g., citric acid, lipases, or proteases). These capsules remain inert during normal use but rupture under mechanical stress or thermal expansion, initiating localized hydrolysis of the surrounding matrix. This can serve as a controlled failure mechanism or as a time-delayed biodegradation trigger, enabling post-use disintegration after a defined interval or mechanical loading event.

Alternatively, the matrix may contain hydrolyzable anhydride or acetal linkages that are stable under dry or ambient conditions but cleave upon prolonged exposure to humidity, initiating chain scission and loss of mechanical integrity. Time-release mechanisms may be embedded via pH-sensitive or moisture-sensitive coatings that dissolve gradually in soil or composting environments, exposing embedded catalysts or hydrophilic segments.

In another variant, degradation may be activated by photoinitiators or UV-reactive agents blended into the polymer. When exposed to natural sunlight or controlled UV radiation (e.g., during recycling triage or field triggering), these additives generate reactive oxygen species or cleave ester linkages within the polymer, accelerating biodegradation. This approach may be particularly useful in agricultural or outdoor signage applications where end-of-life disposal may be passive and unmonitored.

The incorporation of these self-healing or delay-triggered degradation strategies enables the biodegradable chain to maintain peak mechanical performance throughout its intended use phase while providing an engineered mechanism for breakdown post-deployment. This further enhances the invention's adaptability across environments where service life and decomposition timing must be finely balanced.

### Mechanical Use Cases and Functional Variants: Chain Dynamics

The biodegradable plastic chains disclosed herein may be configured to perform reliably under a wide variety of dynamic mechanical loading scenarios, including environments involving vibration, impact, and cyclic tensile or compressive stresses. Unlike static applications, dynamic loading introduces fatigue-related stresses that can lead to failure through crack propagation or polymer creep over time. To mitigate such effects, the polymer matrix may be modified to exhibit enhanced viscoelastic properties, enabling the chain to dissipate energy through internal damping while maintaining dimensional stability.

In vibration-prone applications, such as mounting chains for equipment subject to oscillatory motion (e.g., motor mounts, signage in high-traffic zones), the chain may be engineered with flexibility and high-impact modifiers to prevent embrittlement and premature fatigue. Dynamic load testing has shown that certain formulations retain mechanical integrity after over 10,000 load-unload cycles at stress amplitudes near 40% of ultimate tensile strength, indicating suitability for applications requiring vibration resilience.

The biodegradable chain may also be configured for use in pulleys and hoisting systems where bending, torsion, and surface abrasion occur cyclically. In such applications, the link design may be adapted with rounded geometries to reduce stress concentration and minimize friction between adjacent links. The chain may be employed in low-load lifting systems (e.g., warehouse pull lines, garden or construction hoists) where biodegradability provides an advantage in outdoor or temporary use environments. Lubricity modifiers or low-friction additives (e.g., erucamide, polytetrafluoroethylene micro-powder) may be incorporated to reduce wear between chain and pulley contact surfaces, extending operational life without compromising biodegradability.

In tensioning systems, such as adjustable tie-down mechanisms, fencing supports, or mobile rigging, the chain may experience sustained tensile stress combined with intermittent loading or shock impulses. The link design may be tailored to accommodate elongation without permanent deformation, and plasticizers or elastomeric modifiers may be added to improve ductility and energy absorption under transient load spikes. These modifications allow the biodegradable chain to maintain mechanical utility in load-bearing or load-distribution roles across variable field conditions.

Additionally, shock-loading performance is relevant in applications such as crowd-control barriers, traffic delineators, or marine mooring lines where external impacts are frequent. For such use cases, the chain may be designed with failure strain buffers or mechanical fuses, optionally integrated into the link geometry or polymer composition, which permit controlled breakage under excessive impact forces to prevent collateral damage or injury. These functional variants demonstrate that the biodegradable plastic chain is not limited to static use but is capable of fulfilling demanding dynamic performance requirements across industrial, commercial, and environmental applications.

### End-Use Assembly Scenarios

The biodegradable plastic chains disclosed herein may be integrated with a wide range of mechanical connectors and fasteners to facilitate deployment across diverse end-use assembly scenarios. Specifically, the chain may be used in conjunction with attachment hardware such as carabiner-style hooks, spring-loaded clips, S-hooks, swivels, snap buckles, and threaded or ratcheting tensioners. These assemblies enable the chain to be quickly secured to fixed or mobile anchor points, permitting tool-free installation and removal in both temporary and semi-permanent applications.

In safety barrier applications—such as delineating restricted access zones, construction perimeters, crowd control areas, or temporary walkways—the chain may be suspended between vertical posts using molded hooks or fasteners that interface with apertures formed in or attached to the link geometry. In some embodiments, the chain may be manufactured with integrated eyelets, grommets, or molded lugs that permit direct mechanical engagement with standardized fastener types. The low mass and corrosion resistance of the biodegradable polymer blend make it ideal for outdoor safety demarcation, especially in environmentally sensitive zones where retrieval of long-lived plastics may be impractical.

The chain may also serve as a modular component in signage systems, such as suspending lightweight signs from overhead supports or forming perimeter boundaries with integrated informational placards. To facilitate this, the links may include flat regions or slots for affixing printed inserts, reflective panels, or snap-on label holders. The biodegradable nature of the chain ensures that when used in temporary or seasonal installations (e.g., festivals, agricultural fairgrounds, or parks), the chain can be safely left in place for natural decomposition without long-term environmental persistence.

In modular construction assemblies, the chain may be used as a flexible structural element to connect, tension, or suspend lightweight building components. Examples include use in scaffolding netting, tensile canopy supports, or as temporary bracing systems during concrete formwork setup. The chain's mechanical properties-combined with design options such as high-friction or textured surfaces-enable secure interaction with conventional building materials. Moreover, variants of the chain may include integrally molded attachment fixtures or be designed with standardized dimensions to interface with reusable construction brackets, clips, or clevis systems.

For logistics and material handling applications, the chain may be paired with fasteners or locking devices to secure cargo or create flexible containment systems. In these configurations, the chain can be routed through buckles or cinch locks to form adjustable tensioning loops, suitable for bundling irregularly shaped goods. Upon fulfillment of its use, the chain may be discarded with minimal environmental concern, making it particularly advantageous for single-use or field-deployable applications such as disaster response, humanitarian logistics, or rapid military infrastructure.

### Recyclability Prior to Degradation

In certain embodiments, the biodegradable plastic chains disclosed herein may be collected and reprocessed prior to the onset of significant environmental degradation. The polymer blends used to form the chains—such as polylactic acid (“PLA”), polybutylene succinate (“PBS”), and polycaprolactone (“PCL”)—are thermoplastic in nature prior to crosslinking and thus retain the ability to be re-melted and remolded under appropriate processing conditions. If the chain has not yet been exposed to elevated humidity, composting environments, or other degradation accelerants, it may be shredded, pelletized, and reintroduced into manufacturing streams via extrusion, injection molding, or compression molding techniques.

To facilitate closed-loop or semi-closed-loop recycling, the chains may include embedded recycling markers or visual indicators (e.g., color-change dyes, QR codes) that signify their eligibility for mechanical recovery. In industrial or institutional use cases-such as event management, construction sites, or agricultural deployment-used chains can be collected post-use and segregated before exposure to composting or wet environments. Provided that the chains have not undergone hydrolytic or microbial breakdown, the reprocessed material may retain acceptable mechanical properties, especially when combined with virgin feedstock or compatibilizers to restore viscosity and tensile performance.

In another aspect, the chain composition may be formulated to include thermal stabilizers and antioxidant systems that prevent molecular weight reduction during the initial molding process, enabling the polymer to survive one or more additional melt-cycles. In such embodiments, the reprocessed chain material may be used for lower-spec applications (e.g., ground stakes, signage mounts, filler components) where peak mechanical performance is not required, thereby enhancing material utilization without compromising environmental intent.

Furthermore, certain embodiments may be engineered to be dual-mode: compostable if left in the environment, but also thermally recyclable in controlled manufacturing systems. This dual-path disposition offers supply chain flexibility and supports sustainability initiatives that prioritize both material recovery and environmental degradability. For example, chains used in temporary exhibitions or outdoor retail fixtures can be gathered and diverted to in-house regrind systems if local composting infrastructure is unavailable.

In contrast, once hydrolytic degradation has been initiated-indicated by embrittlement, mass loss, or measurable loss in tensile strength-mechanical recycling is typically no longer viable, and the chain can instead be diverted to composting, anaerobic digestion, or other biological disposal methods. Accordingly, guidance may be provided on handling, reuse timelines, and storage conditions (e.g., relative humidity, temperature limits) to maintain recyclability for a defined pre-degradation window.

### Fire Resistant Use Cases

In certain embodiments, the biodegradable plastic chains disclosed herein may be formulated to include flame-retardant additives or copolymer modifications to meet the fire safety requirements of specialized applications. These include use in environments such as construction sites, vehicle interiors, industrial safety gear, or enclosed public spaces where compliance with fire resistance regulations (e.g., UL 94, FMVSS 302, ASTM E84) is critical.

Flame retardants may be added to improve fire resistance and meet regulatory standards for safety-critical applications. Halogenated flame retardants, such as brominated diphenyl ethers, have traditionally been used in polyolefins, but environmental concerns have led to the adoption of phosphorus-based compounds, including aluminum diethylphosphinate and ammonium polyphosphate. In polylactic acid, intumescent flame retardant systems composed of phosphoric acid derivatives, melamine, and pentaerythritol expand upon heating to form a protective char layer, slowing combustion and reducing heat release rates. The polymer matrix may be compounded with halogen-free flame retardants, such as aluminum diethylphosphinate, magnesium hydroxide, melamine polyphosphate, or ammonium polyphosphate. These additives promote char formation, reduce heat release rate, and suppress smoke production during combustion. The resulting flame-retardant chains may achieve self-extinguishing behavior or delayed ignition properties while maintaining biodegradability in end-of-life environments such as industrial composting or soil burial.

For safety gear applications—including high-visibility barriers, demarcation lines, or equipment lanyards used near hot work zones or electrical systems—the flame-retardant biodegradable chain may offer dual functionality: reduced fire propagation risk during service life and controlled degradation after disposal. In such use cases, the polymer blend may be optimized to preserve flexibility and mechanical integrity while achieving a limiting oxygen index (LOI) of 26% or higher.

In automotive or aerospace applications, such as vehicle interiors, cable guides, or modular attachment systems, the flame-retardant chain may be molded from biodegradable polymers blended with intumescent flame retardant systems. These systems may include phosphorus compounds, carbon sources, and blowing agents that expand into an insulating char layer under heat, reducing thermal conductivity and inhibiting combustion. The resulting formulations may meet FMVSS 302 flammability requirements while maintaining the aesthetic and mechanical properties needed for design integration.

In construction site applications—especially for temporary fencing, utility markers, or hoisting systems near welding or electrical work—the flame-retardant chain provides a safer alternative to conventional polymer chains that may contribute to fire spread. Additionally, the low smoke and low toxicity characteristics of halogen-free flame retardants enhance usability in enclosed or populated environments. After use, the chains may be safely composted or discarded in compliance with green building standards, avoiding the persistence of halogenated residues associated with traditional fire-retardant plastics.

These flame-resistant variants of the biodegradable chain may therefore expand the utility of the invention into regulated safety-critical domains while preserving environmental compatibility and sustainable lifecycle characteristics.

### Chain Form Variants

In some embodiments, the biodegradable chain may be designed as an integrated hybrid structure, combining multiple materials within each link to enhance performance characteristics while preserving environmental benefits. A representative example includes a metal-core/bio-shell configuration, wherein a rigid or flexible metal filament, rod, or frame is embedded within a molded biodegradable polymer outer shell. This construction provides enhanced tensile strength and dimensional stability while enabling degradation of the external polymer under composting, soil, or marine conditions.

The metal core may be formed from steel, aluminum, zinc alloys, or corrosion-resistant materials such as stainless steel or galvanically treated metals. It may be continuous (running through a chain length) or localized within individual links. The outer biodegradable shell may be overmolded onto the core using conventional co-molding or two-shot injection molding techniques. In alternative embodiments, the metal core may be removable or recyclable after the polymer shell degrades, supporting partial material recovery while enabling environmental degradation of the outer layer.

Conversely, in inverse configurations, the chain may include a biodegradable core surrounded by a semi-permanent or reprocessable outer jacket. This may be desirable where surface durability, visual aesthetics, or short-term environmental shielding (e.g., UV, moisture) is required. Such a jacket may be formed from polyolefins, silicone rubbers, or thermoplastic elastomers and may be peelable, segmental, or perforated to enable removal before composting. Hybrid chain designs may be used in semi-permanent barrier systems, signage installations, or agricultural settings where functional life spans must be extended before triggering biodegradation.

### Textured and Surface Modified Chains

In further embodiments, the chain may incorporate surface texturing or post-molding treatments to improve functional utility, durability, or user interaction. For instance, chains designed for outdoor or wet conditions may be fabricated with anti-slip surface profiles. This may be accomplished by embossing or etching raised patterns-such as knurls, ridges, microgrooves, or crosshatch lattices-onto the exterior of each link during molding or through post-processing techniques like laser ablation or surface blasting.

Alternatively, the surface of the biodegradable polymer may be treated or coated with thin functional layers that modify environmental interaction. A hydrophobic surface coating—such as wax, polyurethane dispersion, or biodegradable silicone emulsion—may be applied to delay the onset of hydrolysis or microbial attack, effectively extending usable life in high-humidity or rain-prone environments. Such coatings may be engineered to erode over time or crack upon mechanical wear, thereby initiating degradation only after the product has served its function.

In applications requiring human interaction (e.g., handles, rigging, or tethering), soft-touch or high-friction coatings may be applied for grip and safety, such as natural rubber latex, biodegradable thermoplastic elastomers, or corn starch-derived polymers. These surface modifications support ergonomic use without compromising the overall compostability or environmental fate of the device.

### Modular or Segmented Chains

Modular chain configurations may also be employed to support on-site customization, easy assembly, or controlled failure modes. In these embodiments, the individual chain links may include integrated snap-fit joints, ratcheting lock arms, or flexible hinge mechanisms that allow the user to assemble or disassemble chain segments without the use of tools. The joints may include over-center locking features or resilient interlocking tabs that resist unintentional disengagement under load.

In some configurations, a segmental design may allow for the selective replacement of damaged or worn links, supporting modular repair and extending the product's effective service life before full degradation. Modular segments may be color-coded, barcoded, or include strain indicators to support load balancing or usage tracking in industrial applications. For example, links with embedded strain relief ribs may deform visibly after excessive loading, signaling replacement need or triggering controlled breakage.

Modular chains are particularly useful in logistics, signage deployment, or agricultural environments where users must rapidly configure chain lengths to accommodate varying site conditions. Chains may be distributed in standardized units (e.g., 1-foot lengths), with ends configured for tool-less interlocking assembly. In one example, a field technician deploying crowd-control fencing could adjust a chain's length dynamically by adding or removing segments in response to terrain or post spacing, avoiding waste and increasing reuse efficiency.

These form factor variants-whether hybrid, surface-modified, or modular demonstrate the broad adaptability of the biodegradable chain technology, supporting customization for specific mechanical, ergonomic, aesthetic, or environmental requirements while retaining the core benefit of sustainable degradation at end of life.

### Environmental Performance

The biodegradable plastic chains disclosed herein may be engineered to perform across a diverse range of environmental conditions while retaining mechanical integrity during use and undergoing controlled degradation post-disposal. These environments may include fresh water, salt water, anaerobic landfills, desert/arid climates, and cold-temperature ecosystems.

In freshwater environments, such as lakes, rivers, and stormwater runoff channels, the polymer matrix may be formulated to resist premature hydrolysis while submerged. Degradation under these conditions may proceed more slowly than in industrial composting but may still occur within 12-24 months, depending on microbial activity, water pH, and oxygen availability. Applications may include buoyant safety lines, aquatic fencing, or temporary water control systems.

In marine and saltwater conditions, such as coastal deployment or floating barrier systems, the polymer blend may incorporate salt-resistant stabilizers and marine-compatible plasticizers. Salt ions can catalyze hydrolysis in ester-based polymers, so formulations may be adjusted for slower degradation to maintain integrity. Under ASTM D6691 conditions (marine biodegradation), certain PLA/PHA blends have shown 30-50% degradation within 180 days.

In anaerobic landfill environments, such as capped waste disposal systems, the absence of oxygen and reduced microbial diversity can limit degradation rates. However, the inclusion of anaerobically digestible components—such as PBAT, starch blends, or cellulose fillers—can facilitate partial degradation by methanogenic bacteria. Gas capture systems may collect released CO₂ and CH₄ as part of renewable energy recovery, minimizing environmental impact.

In arid or desert environments, where ambient humidity is low and microbial activity is limited, the chain may exhibit long-term stability, persisting for extended periods until exposed to moisture. This property can be advantageous for temporary installations in dry climates, such as fencing, agricultural netting, or construction perimeters. Once exposed to rainfall or irrigation, hydrolysis and microbial colonization can proceed, initiating the breakdown process.

In cold climates, including subarctic or alpine settings, degradation may be significantly slowed due to reduced microbial metabolism and water mobility. The polymer matrix may include cryo-stabilizers or retain flexibility at sub-zero temperatures (e.g., down to −20° C.) to avoid brittleness or cracking during use. Once ambient temperatures rise or the material is transported to composting facilities, degradation can proceed under standard conditions.

Upon degradation, the biodegradable polymers used in the chain composition release a variety of benign, low-toxicity breakdown products. For example, polylactic acid (PLA) degrades via hydrolysis to form lactic acid, a naturally occurring compound commonly found in fermented foods and safe for environmental and biological exposure. Lactic acid is further metabolized by soil and aquatic microorganisms into CO₂ and water.

Polybutylene succinate (“PBS”) yields succinic acid and 1,4-butanediol upon ester hydrolysis. Succinic acid is a key intermediate in the citric acid cycle and readily metabolized by a wide range of microbial species. Butanediol is water-soluble and ultimately oxidized into CO₂ and biomass in aerobic systems.

Polycaprolactone (“PCL”) breaks down to 6-hydroxyhexanoic acid, which is further degraded by microorganisms. PCL's slow, surface-eroding profile enables sustained release of low-molecular-weight oligomers that are assimilated over time in both soil and marine ecosystems.

In composite or copolymer systems, degradation products may also include short-chain fatty acids, CO₂, H₂O, methane (in anaerobic conditions), and trace alcohols or glycols depending on initiators and residual monomers. These species do not bioaccumulate and exhibit low aquatic and terrestrial toxicity under standard conditions.

Environmental safety may be further assured by excluding halogenated additives, heavy metals, or persistent organic compounds from the formulation. Additives such as antioxidants, UV stabilizers, or plasticizers may be selected from biodegradable, bio-assimilable, or GRAS-listed categories to ensure that all constituents break down into ecologically neutral compounds. No microplastics or persistent particulate matter remain following complete biodegradation.

### Manufacturing Processes

The biodegradable plastic chains disclosed herein may be fabricated using a variety of polymer processing techniques, depending on the target geometry, production volume, and material properties. Representative molding techniques include injection molding, compression molding, extrusion, and additive manufacturing, each of which may be optimized for biodegradable polymer blends.

In injection molding, the biodegradable polymer blend—optionally pre-compounded with additives, fillers, or reinforcement fibers—is heated above its melting or softening point and injected into a multi-part mold corresponding to the chain link geometry. Cycle times, injection pressure, and mold temperatures may be adjusted to ensure complete filling and minimal degradation of thermally sensitive biopolymers such as PLA or PHA. Injection molding enables the mass production of uniform, mechanically interlocking links with precision tolerances and integrated features such as locking tabs, texture, or embedded markers.

Compression molding may be used for bulkier chain components or hybrid structures. In this process, a pre-measured polymer charge is placed into a heated mold cavity and subjected to pressure until the polymer flows and conforms to the mold shape. This approach is advantageous for incorporating fiber reinforcements or biocomposites with lower flowability and can accommodate co-molding of multi-material systems (e.g., metal-reinforced biodegradable links).

For continuous-chain products such as safety fencing, flexible chains, or rope-analogous designs, extrusion may be employed. In this method, the biodegradable polymer is fed through a heated screw barrel and forced through a die of the desired profile. Extruded profiles may be cooled via water baths, air cooling, or vacuum calibration to stabilize geometry. Perforations or link geometries may be introduced in-line or in secondary operations.

Additive manufacturing techniques, particularly fused deposition modeling (FDM) and selective laser sintering (SLS), may be used to fabricate complex or customized biodegradable chain components. PLA-based filaments or powders derived from PCL, PBAT, or modified starch blends may serve as feedstock for these methods. Additive manufacturing enables rapid prototyping, low-volume production, and geometric features such as internal cavities or embedded sensing channels that are difficult to achieve with traditional molding.

Following primary shaping, post-processing steps may be employed to enhance mechanical durability, thermal stability, or environmental resistance of the biodegradable chains. These treatments may include annealing, UV-curing, coating, or plasma surface modification.

Annealing may be performed by subjecting the molded parts to elevated temperatures below the melting point for a defined duration (e.g., 80-120° C. for PLA), promoting increased crystallinity and reducing internal stresses. This results in improved dimensional stability, higher heat deflection temperatures, and reduced brittleness-particularly beneficial in load-bearing or cyclic stress applications.

UV-curing processes may be applied to coated or surface-functionalized chains using photo-crosslinkable additives or oligomers. This can create abrasion-resistant or hydrophobic outer layers that delay degradation under humid or UV-exposed conditions. For example, biodegradable acrylate coatings can be cured under mercury arc or LED UV lamps to enhance outdoor durability.

Surface treatments, including corona discharge, plasma etching, or graft polymerization, may modify the outermost polymer layer to increase adhesion, roughness, or functional reactivity. This may be used to enhance bonding of labels, improve paintability, or enable subsequent layering of antimicrobial or anti-slip coatings. These treatments are particularly useful for consumer-facing applications or multi-use systems.

In some embodiments, the biodegradable chain may be equipped with in-line degradation indicators to signal the onset or progression of environmental breakdown. These features may include fading dyes, colorimetric pH indicators, time-temperature integrators, or embedded RFID/NFC tags programmed to reflect usage data or material integrity.

A representative example includes the use of encapsulated pH-sensitive dyes that change color upon acid formation during polymer hydrolysis. Such indicators may transition from blue to yellow or red as degradation byproducts (e.g., lactic acid, succinic acid) accumulate within the polymer matrix, offering a visual cue of end-of-life proximity.

Alternatively, time-dependent or UV-sensitive dyes may be incorporated into the chain during molding. These materials gradually fade or shift hue after cumulative exposure to sunlight or ambient conditions, serving as passive lifetime indicators. For example, a chain deployed outdoors may exhibit a color shift from green to clear after 90 days, indicating that it should be removed or replaced.

More advanced embodiments may employ low-cost RFID or NFC tags embedded into the chain links. These tags may store data such as deployment time, environmental exposure logs (via integrated sensors), or usage history. In commercial or industrial systems, such features enable proactive maintenance or automated recycling triage by reading degradation status at collection points.

These in-line sensing mechanisms ensure that biodegradable chains can be monitored for safe removal, prevent premature failure in critical applications, and support regulatory compliance for field-deployed biodegradable materials. The ability to correlate visible or electronic indicators with degradation state provides a critical link between functional design and responsible environmental deployment.

### Applications

The biodegradable plastic chain disclosed herein may be applied across a broad range of industrial, commercial, agricultural, and consumer contexts, particularly where temporary utility and environmental responsibility are prioritized. Because the chain retains desirable mechanical properties such as tensile strength, elongation, UV resistance, and thermal stability for a defined period prior to degradation, it is uniquely suited to applications where retrieval and recycling may be impractical or undesirable.

In construction and infrastructure, the chain may be used for temporary fencing, scaffolding bracing, debris containment netting, or equipment tagging. For example, a site manager could deploy the chain to demarcate exclusion zones or pedestrian paths, confident that the chain will maintain mechanical integrity for months under sunlight and moderate loads but degrade naturally if buried or left behind. Hybrid variants with metal cores may be used where higher load-bearing capacity is required without compromising disposal characteristics.

In agriculture, the chain may serve as a biodegradable trellis system for climbing crops (e.g., tomatoes, beans, hops), livestock tethers, or temporary field fencing. The moisture-sensitive degradation profile can be tuned to degrade after harvest or rainfall exposure, minimizing labor associated with post-season cleanup and eliminating plastic residue in soil.

In marine and water-based deployments, such as floating barriers, buoy tethers, aquaculture netting, or temporary mooring lines, the chain may function in saltwater or freshwater environments before undergoing controlled breakdown. Use of UV stabilizers and salt-resistant polymer blends ensures operational stability, while eventual biodegradation minimizes microplastic and marine litter accumulation.

In event management or crowd control, the chain may be used for barrier systems, queue lines, or sign supports. Because these events are temporary and often occur in public or outdoor spaces, the biodegradable chain offers a sustainable alternative to petroleum-based plastic chains that might otherwise be discarded.

In retail or logistics, the chain may serve as light-duty cargo tie-downs, product bundling aids, or hanging display elements. For example, seasonal merchandise suspended with biodegradable chains could be composted with packaging waste, reducing the burden on solid waste systems and supporting corporate sustainability initiatives.

In consumer products, shorter segments of chain may be used in gardening kits, pet products (e.g., leashes or toys), educational materials, or outdoor furniture accessories. These products may be engineered for multiple months of use and subsequently degrade harmlessly when exposed to the environment.

In emergency and humanitarian contexts, where rapid infrastructure deployment is required and post-use retrieval is infeasible, the chain may be used in makeshift shelters, temporary power line supports, potable water suspension systems, or medical triage perimeters. In these situations, reducing environmental load and logistical burden is a critical advantage.

These diverse hypothetical applications demonstrate the flexibility of the biodegradable chain technology, enabling environmentally compatible performance across varied industries while minimizing long-term waste accumulation. The material design, functional lifespan, and degradation pathway can be tailored to the specific environmental and mechanical demands of each use case.

### Figure

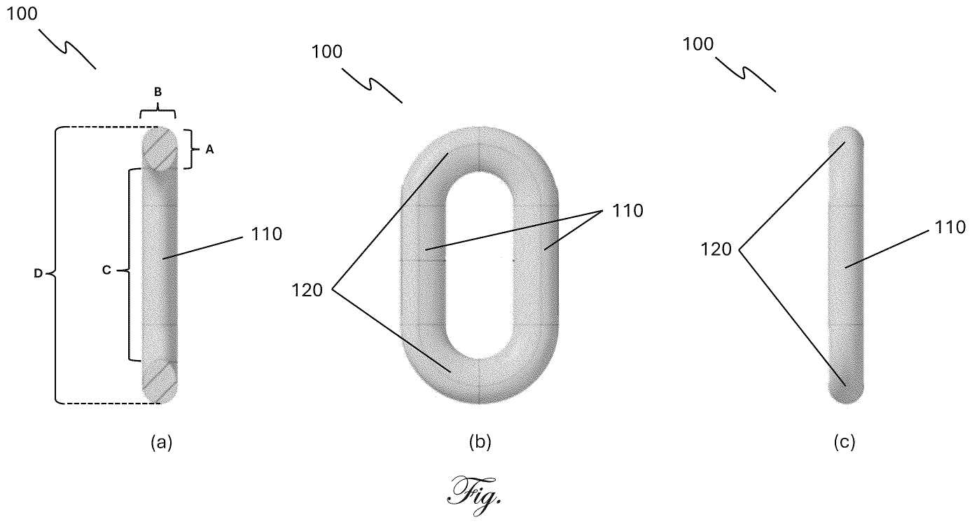

Turning to the FIGURE, an oval link 100 is shown. A major axis travels the longest length of the link, and a minor axis travels down the shortest length of the axis, perpendicular to the major axis. The link 100 has three major sections, sides 110 and top and bottom crown 120. The sides 100 are flat, and the crowns begin when the flat portion of the link begins to turn to create an arc. FIG. 1(a) shows a cross section of a side view of the link, dissected in half such that the crown 120 is cut in the center down the major axis. FIG. 1(b) shows a front view of the link. FIG. 1(c) shows a side view of the link, but it is not a cross-section. Dimension A represents the thickness of the link from the inner edge to the outer edge. Dimension B represents the thickness of the link from the front to the back of the link. Notably, dimensions A and B need not be the same to create a “circular” cross section for the link. As shown here, dimension A is longer than dimension B. This is a compromise between creating a thicker material to enhance the physical properties of the link but not waste material that would be nonfunction on the front and back of the link. Dimension C is length between the bottom of the top crown 120 and the top of the bottom crown 120. Dimension D is the height of the link down the major axis, which could be described as the length between the top of the top crown 120 and the bottom of the bottom crown 120. Naturally, dimensions A is related to dimensions C and D according to the following formula:

D=2A+C Eq. 1

The dimensions of the link will be described in terms of generic units for the purpose of showing only relative dimensions, which can be scaled by changing the units. However, we will note possible units below, and each combination of units and dimensions is contemplated. Dimension A is 0.30 inches as shown, but can be 0.10 to 2.0 units, preferably 0.20 to 1.0 units, or more preferably 0.25 to 0.5 units. Dimension B is 0.23 inches as shown, but can be 0.05 to 1.5 units, preferably 0.10 to 0.75 units, or more preferably 0.20 to 0.30 units. Dimension C is 1.32 inches as shown, but can be 0.50 to 4.0 units, preferably 0.75 to 2.0 units, or more preferably 1.0 to 1.5 units. Dimension D is 1.93 inches as shown but can be any dimensions that is possible by calculating it from dimensions C and A, using Eq. 1, for any combinations of A and C above.

A chain comprises at least one link and more often a plurality of interlocking links, the at least one link used to support a portion of a mechanical load or to mechanically connect two or more objects.

### Example One of the Biodegradable Chain

In one aspect of the invention, the novel biodegradable chain may be made from a blend of biodegradable polymers such as polylactic acid, polybutylene succinate, and polycaprolactone, sourced from plant-based biomass. The polymer blend may be processed into interlocking links to form a chain that maintains mechanical integrity for at least several months under standard use conditions.

The chain may have a tensile strength of at least 50 pounds-force, preferably at least 60 pounds-force, and more preferably at least 70 pounds-force. Alternatively, the tensile strength may range between 70 and 95 pounds-force, preferably between 75 and 90 pounds-force, and more preferably between 78 and 85 pounds-force, ensuring sufficient durability under sustained loads.

The elongation at break may be at least 30 percent, preferably at least 40 percent, and more preferably at least 50 percent. Alternatively, the elongation at break may range between 45 and 60 percent, preferably between 48 and 56 percent, and more preferably between 50 and 54 percent, ensuring moderate ductility and resistance to sudden fracture under load.

The chain's load-bearing capacity over extended periods may range between 20 and 30 pounds for at least 15 days without failure, preferably between 22 and 28 pounds, and more preferably between 24 and 26 pounds, ensuring it maintains mechanical integrity under common industrial and commercial applications. At loads exceeding 30 pounds, the chain may experience failure in fewer than 2 days, ensuring predictable mechanical limits.

Heat resistance may be engineered to ensure long-term durability under elevated temperatures. The chain may have a heat deflection temperature of at least 50 degrees Celsius, preferably at least 52 degrees Celsius, and more preferably at least 54 degrees Celsius. Alternatively, the heat deflection temperature may range between 50 and 65 degrees Celsius, preferably between 52 and 60 degrees Celsius, and more preferably between 54 and 58 degrees Celsius, ensuring resistance to softening under moderate thermal exposure. Under controlled heat aging at 55 degrees Celsius, the chain may retain its mechanical properties with no significant changes for at least 8 hours, ensuring reliability in warm environments.

The ultraviolet stability of the chain may allow for exposure to 96 hours of accelerated UV aging at 60 degrees Celsius without structural degradation. Preferably, the chain may maintain at least 90 percent of its mechanical integrity after exposure, and more preferably at least 95 percent, ensuring suitability for outdoor applications.

The chain's biodegradability may be engineered for controlled environmental breakdown. Under industrial composting conditions, the chain may degrade by at least 30 percent within 180 days, preferably at least 40 percent, and more preferably at least 50 percent, ensuring compliance with composability standards. In ambient soil burial conditions, the chain may degrade by at least 20 percent within 12 months, preferably at least 30 percent, and more preferably at least 40 percent, allowing for predictable environmental decomposition.

The moisture absorption rate may range between 0.01 and 3.0 percent by weight over 30 days, preferably between 0.5 and 2.5 percent, and more preferably between 0.8 and 2.0 percent, ensuring that it resists premature degradation under high humidity while still facilitating microbial and hydrolytic breakdown upon disposal.

As used herein, “standard conditions” means 0% humidity, 25° C., and 1 atm of pressure. As used herein, “composting conditions” means conditions in which a material is placed in soil or another composting medium having a carbon-to-nitrogen ratio of 25:1 to 30:1, a moisture content of 40-60% by weight, an oxygen concentration in the gaseous phase of the medium of 12-15% by volume, and a temperature of at least 10° C., sufficient to support aerobic microbial degradation of organic matter.

Hydrolytic degradation may be controlled by adjusting polymer composition and catalyst presence, allowing the chain to maintain at least 24 months of mechanical integrity under normal use conditions while becoming susceptible to enzymatic and microbial degradation upon exposure to composting environments, marine conditions, or landfill biota.

The invention thus provides a biodegradable chain with mechanical properties consistent with conventional plastic chains while ensuring responsible degradation at the end of its service life.

### Definitions and Interpretation

It is understood that the present subject matter may be embodied in various forms and should not be construed as being limited to the specific embodiments described herein. Rather, these embodiments are provided to ensure the subject matter is thorough and complete and to fully convey the disclosure to those skilled in the art. Indeed, the present subject matter is intended to encompass alternatives, modifications, and equivalents of these embodiments, which are included within the scope and spirit of the subject matter as defined by the appended claims and their equivalents. Additionally, in the detailed description of the present subject matter, numerous specific details are set forth to provide a comprehensive understanding of the disclosure. However, it will be evident to those of ordinary skill in the art that the present subject matter may be practiced without such specific details.

The terminology used in this document is for the purpose of describing specific aspects of the disclosure and is not intended to limit its scope. With specific reference to the disclosure, but not the claims, the singular forms “a,” “an,” and “the” include the plural unless the context indicates otherwise. Furthermore, the terms “comprises” and/or “comprising” are intended to specify the presence of stated features, elements, or components, but do not exclude the presence or addition of other features, elements, or components.

The description of the present disclosure is intended to illustrate and describe the disclosure but is not exhaustive or limited to the disclosed form. Many modifications and variations will be apparent to those skilled in the art without departing from the spirit and scope of the disclosure. The aspects of the disclosure were chosen and described to best explain the principles and practical applications, enabling others skilled in the art to understand the disclosure and apply various modifications that may suit specific uses.

Although the subject matter has been described in terms specific to structural features and/or methodological acts, it is to be understood that the subject matter defined by the appended claims is not limited to the specific features or acts described. Rather, the described features and acts are presented as examples of implementing the claims.

Throughout this disclosure, the term “plastic” is used in reference to various materials and compositions, including those that may undergo cross-linking. As one of ordinary skill in the art would appreciate, once a plastic is cross-linked, it transitions into a thermoset material and no longer functions as a thermoplastic. However, it remains derived from plastic materials. Accordingly, when interpreting this specification and the claims, a skilled artisan would recognize whether the term “plastic” refers to a plastic precursor (which may include materials that can be cross-linked) or a plastic product (which would not include cross-linked plastics in their final form).

As would be understood by one skilled in the art, each instance of the term “plastic” herein is intended to encompass, in the alternative, plastic materials (excluding cross-linked plastics), products made from plastic materials (which may include thermoset materials), or both plastic materials and products made from them. In essence, the use of the term “plastic” may, depending on the context, refer to: (1) plastic products, (2) products made from plastic materials, or (3) both plastic products and products made from plastic materials. This disclosure should be interpreted broadly to preserve the full intended scope of these alternatives, except where such an interpretation would be scientifically unsound or where the context clearly indicates that not all alternatives are applicable.

We claim:

1. A load bearing chain comprising:
a polymer matrix comprising a plant-based biodegradable polymer material;
wherein the chain is biodegradable; and
wherein the chain exhibits:
a tensile strength of at least 20 MPa; and
an elongation at break of at least 10%.

2. The article of claim 1, wherein the polymer matrix additionally comprises at least one polymer having at least one monomer unit derived from a renewable plant source selected from polylactic acid, polybutylene succinate, and polycaprolactone.

3. The article of claim 1, wherein the polymer matrix additionally comprises one or more additives selected from the group consisting of fire retardants, ultraviolet stabilizers, antioxidants, compatibilizers, plasticizers, and nucleating agents.

4. The article of claim 1, wherein the polymer matrix is cross-linked by use of a cross-linking agent comprising a silane or peroxide, or by applying radiation.

5. The article of claim 1, wherein the polymer matrix exhibits a moisture absorption rate between 0.01 and 3.0 percent by weight over 30 days.

6. The article of claim 1, wherein the chain exhibits a tensile strength of at least 50 MPa and an elongation at break of at least 30%.

7. A method of manufacturing a load bearing chain comprising:
providing a polymer matrix comprising a plant-based biodegradable polymer material;
forming the polymer matrix into a plurality of interlocking links;
wherein the chain is biodegradable; and
wherein the chain exhibits:
a tensile strength of at least 20 MPa; and
an elongation at break of at least 10%.

8. The method of claim 7, wherein the polymer matrix additionally comprises at least one polymer having at least one monomer unit derived from a renewable plant source selected from the group consisting of polylactic acid, polybutylene succinate, and polycaprolactone.

9. The method of claim 7, further comprising compounding the polymer matrix with at least one additive selected from the group consisting of fire retardants, ultraviolet stabilizers, antioxidants, compatibilizers, plasticizers, and nucleating agents.

10. The method of claim 7, further comprising cross-linking the polymer matrix by use of a cross-linking agent comprising a silane or peroxide, or by applying radiation.

11. The method of claim 7, wherein the polymer matrix exhibits a moisture absorption rate between 0.01 and 3.0 percent by weight over 30 days.

12. The method of claim 7, wherein the chain exhibits a tensile strength of at least 50 MPa and an elongation at break of at least 30%.

13. The method of claim 7, wherein forming the polymer matrix into a plurality of interlocking links comprises molding the polymer matrix in a mold configured to form interlocking link shapes.

14. The method of claim 7, wherein forming the polymer matrix into a plurality of interlocking links comprises extruding the polymer matrix into a continuous profile and cutting the profile into individual link segments, followed by assembling the link segments into interlocking links.

15. A method of using a load-bearing chain, the method comprising:
providing a load-bearing chain comprising:
(a) a polymer matrix comprising a plant-based biodegradable polymer material;
(b) a plurality of interlocking links;
(c) wherein the chain is biodegradable; and
(d) wherein the chain exhibits:
(i) a tensile strength of at least 20 MPa; and
(ii) an elongation at break of at least 10%; and
deploying the chain to support a mechanical load or to mechanically connect two or more objects.

16. The method of claim 15, wherein the polymer matrix additionally comprises at least one polymer having at least one monomer unit derived from a renewable plant source selected from the group consisting of polylactic acid, polybutylene succinate, and polycaprolactone.

17. The method of claim 15, wherein the polymer matrix additionally comprises one or more additives selected from the group consisting of fire retardants, ultraviolet stabilizers, antioxidants, compatibilizers, plasticizers, and nucleating agents.

18. The method of claim 15, wherein the polymer matrix is cross-linked by use of a cross-linking agent comprising a silane or peroxide, or by applying radiation.

19. The method of claim 15, wherein the polymer matrix exhibits a moisture absorption rate between 0.01 and 3.0 percent by weight over 30 days.

20. The method of claim 15, wherein the chain exhibits a tensile strength of at least 50 MPa) and an elongation at break of at least 30%.
